(19) United States
(12) Patent Application Publication
(10) Pub. No.: US 2014/0116098 A1
(43) Pub. Date: May 1, 2014

(54) ENGAGEMENT STRUCTURE FOR CABLE HEAD

(71) Applicant: LINTEX CO., LTD., ZHANGHUA COUNTY (TW)

(72) Inventor: CHIA-SHENG LIN, ZHANGHUA COUNTY (TW)

(73) Assignee: LINTEX CO., LTD., ZHANGHUA COUNTY (TW)

(21) Appl. No.: 13/739,971

(22) Filed: Jan. 11, 2013

(30) Foreign Application Priority Data
Oct. 26, 2012 (TW) 101220773

(51) Int. Cl. E05B 73/00

(52) U.S. Cl. CPC E05B 73/0082
USPC 70/15

(57) ABSTRACT

An engagement structure for cable head of the present invention includes a main body, a cable head, and a release mechanism. The main body has movable positioner disposed thereon. When the cable head is inserted in the main body, the positioner is temporarily pushed away and is moved back by an elastic mechanism to block the cable head from removing from the main body. For removing the cable head, a release mechanism is configured for pushing the positioner away. Thus, user can remove the cable head by operating the release mechanism. Therefore, operation of the engagement structure is simplified for user.

### BACKGROUND OF THE INVENTION

1. Field of the Invention

The present invention relates to a structure which engages releasably with a cable head, providing functions of locking and releasing.

2. Description of the Prior Art

Accompanied with technology improvement, electronic products, such as mobile phones and tablet personal computers, are now popularized to consumer. To fulfill portability purpose, the electronic products are provided with minimized sizes. However, the smaller sizes the electronic products have, the easier the thievery occurs, especially in hypermarkets and exhibitions. To preventing thievery, the electronic products are always firmly engaged with and protected by locks. Thus, unauthorized possession of the electronic products can be effectively forbidden.

In cases of computer, laptop computers are usually provided with slots with which are adapted for locks to engage. Conventional locks, such as the lock described in TW Utility Model No. M407943, are operated with keys to drive a guiding seat to lead a movement of a pin. The pin is moved along a mortise which is inserted in the slot provided on the computer and is moved into the slot. Thus, the mortise and the pin are configured to engage with the computer together.

However, the lock is too complicated to use. The mortise has to be inserted into the slot firstly, or the engagement achieved by insertion of the pin would be failure. Therefore, the conventional locks are inconvenient for user.

The present invention is, therefore, arisen to obviate or at least mitigate the above mentioned disadvantages.

### SUMMARY OF THE INVENTION

The main object of the present invention is to provide a structure for locking quickly and easily.

To achieve the above and other objects, an engagement structure for cable head of the present invention includes a main body, a cable head, and a release mechanism.

The main body has at least a positioner and an elastic mechanism disposed thereon. The positioner is able to move with respect to the main body between a first position and a second position. The elastic mechanism drives the positioner to move toward the first position.

One end of the cable head is formed with an insertion end. The insertion end inserts removably in the main body. The positioner blocks the insertion end when the positioner is located at the first position, so that the main body and the cable head are unable to be separated from each other. The insertion end is able to move in and out from the main body arbitrarily when the positioner is located at the second position. The insertion end has a first pushing portion. The first pushing portion presses the positioner toward the second position during motion of the insertion end inserting in the main body. The positioner is moved to the first position by the elastic mechanism and blocks the insertion end after the insertion end is inserted in the main body.

The release mechanism selectively drives the positioner to move to the second position.

Accordingly, user can insert the cable head directly into the main body for locking. The positioner would be driven by the elastic mechanism and would block and engage the cable head automatically. Therefore, the operation of the lock is simplified, fast and easy.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial breakdown drawing showing a first embodiment of the present invention;

FIG. 2 and FIG. 3 are stereograms showing a first embodiment of the present invention;

FIG. 4 and FIG. 5 are schematic drawings showing an operation condition of a first embodiment of the present invention;

FIG. 6 is a partial breakdown drawing showing a second embodiment of the present invention;

FIG. 7 is a stereogram showing a second embodiment of the present invention;

FIG. 8 and FIG. 9 are schematic drawings showing an operation condition of a second embodiment of the present invention.

### DETAILED DESCRIPTION OF THE PREFERRED EMBODIMENTS

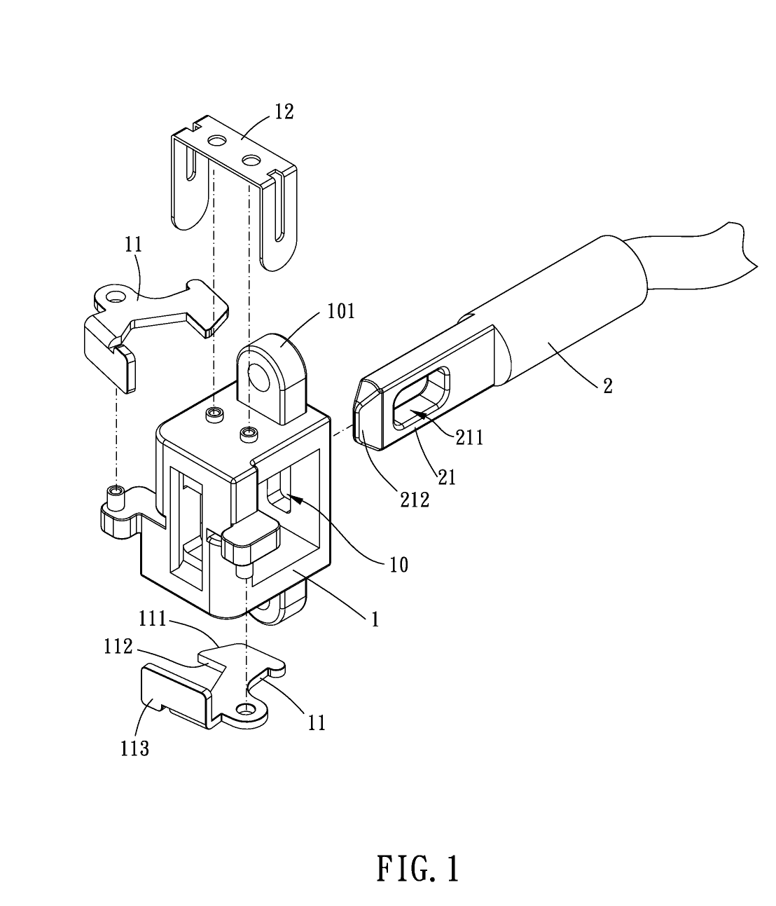

Please refer to FIG. 1 to FIG. 3 for a first embodiment of the present invention. The engagement structure for cable head of the present embodiment includes a main body 1, a cable head 2, and a release mechanism 3.

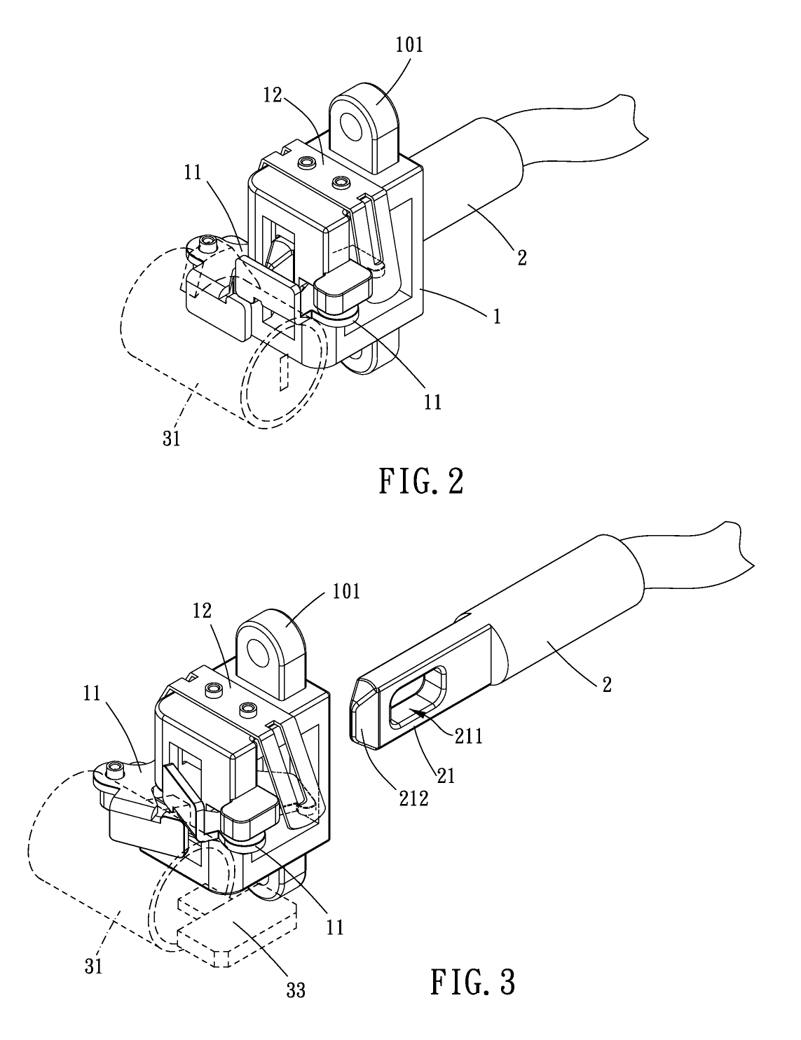

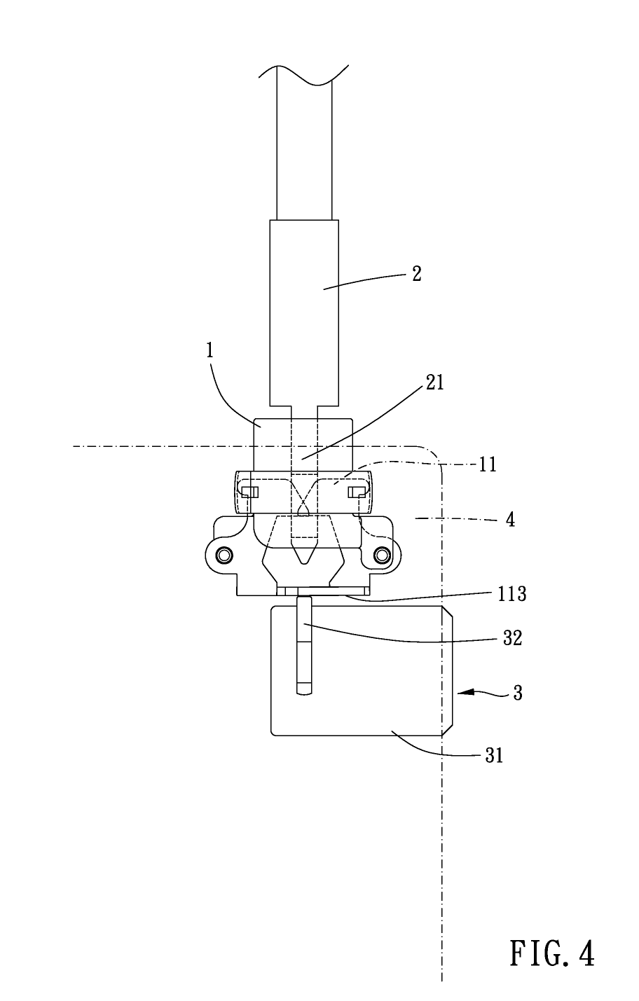

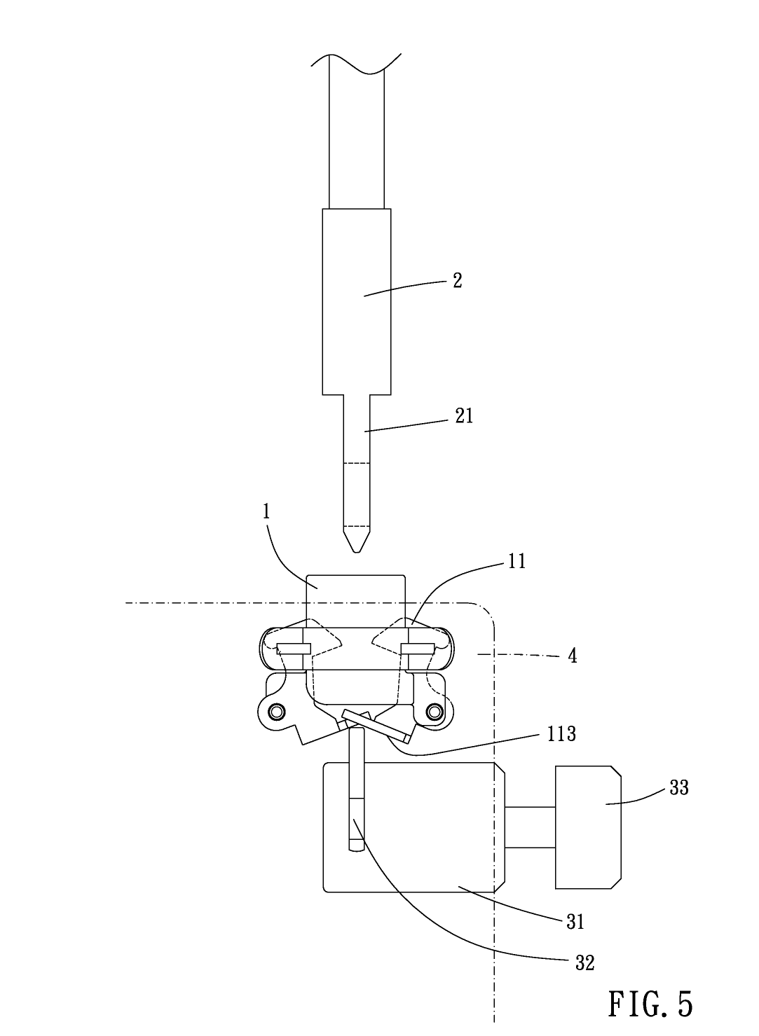

The main body 1 is formed with a through hole 10 and a connection portion 101. In the present embodiment, the connection portion 101 has a hole which is provided for fixing the main body 1 on an electronic product or other structures by threads. Of course, the connection portion may be provided in other formation to mate with the structure with which the engagement structure is going to fit. The main body 1 has two positioners 11 and an elastic mechanism 12 which are disposed on the main body 1. The positioners 11 pivot on the main body 1 respectively, so that the positioners 11 are able to move with respect to the main body 1 between a first position and a second position by rotating. Each of the positioners 11 has a first end and a second end. The first end has a guiding portion 111 and a hook portion 112. In the present embodiment, the guiding portion 111 is an edge structure which extends slantly along an extension direction of the edge structure. In some cases, the guiding portion 111 may be a tilted surface structure. The second end has a guiding surface 113. When the positioners 11 are located at the first positions thereof, as shown in FIG. 1, FIG. 2, and FIG. 4, the hook portions 112 are located close to each other. Preferably, the positioners 11 are located at different altitude, and the hook portions 112 slightly overlap with each other. The guiding surfaces 113 of the postioners 11 are parallel to each other. When the positioners 11 are located at the second positions thereof, as shown in FIG. 1, FIG. 3, and FIG. 5, the hook portions 112 are located away from each other.

The elastic mechanism 12 drives the positioners 11 to move toward the first positions thereof. In the present embodiment, the elastic mechanism 12 is a slice buckle. The elastic mechanism 12 is disposed on the main body 1, pressing on the positioners 11 by mains of clipping so as to move the positioners 11 toward the first positions. Thus, the hook portions 112 have tendency to move close to each other. In other possible embodiments of the present invention, the elastic mechanism may be springs which are disposed between the positioner and the main body so as to push the positioners toward the first position. In some other possible embodiments of the present invention, the elastic mechanism may be leaf springs which are formed directly on one of the position and the main body. Once one of the positioner and the main body is formed with the leaf spring, the leaf spring can push against the other one so as to drive the positioner to move toward the first position. Therefore, the elastic mechanism is used for driving the positioners toward the first positions. The elastic mechanism may be a unique component independent form the others, or the elastic mechanism can also be a partial structure of the positioners or the main body.

One end of the cable head 2 is formed with an insertion end 21, the other end is adapted for wires, lines, or other structures to connect to. The insertion end 21 inserts removably in the main body 1 via the through hole 10. When the insertion end 21 is inserted in the main body 1, the positioners 11 are located at two corresponding sides of the insertion end 21. In other words, the insertion end 21 is inserted and located between the positioners 11. The insertion end 21 has a limiting portion 211 which is a through hole in the present embodiment. When the positioners 11 are located at the first positions, the hook portion 112 of the positioners 11 block the limiting portion 211 of the insertion end 21, so that the main body 1 and the cable head 2 are unable to be separated from each other. The term “block” is taken only in that the hook portion 112 is able to limiting movement of the insertion end 21 and keeping the main body 1 and the cable head 2 together. That is to say, the hook portion 112 is not necessary to touch the insertion end 21 continuously. In other possible embodiments of the present invention, the limiting portion may be formed as grooves, protrusions, or other structures corresponding to the hook portion. When the positioners 11 are located at the second positions thereof, the hook portions 112 are located away from each other, and the insertion end 21 is able to move in and out from the main body 1 arbitrarily. The insertion end 21 has a first pushing portion which includes two surfaces 212 tilted with respect to each other. As such, the distal end of the insertion end 21 is shrunk as a ridge or a pyramid. When the insertion end 21 is inserted into the main body 1, the surfaces 212 are parallel to the guiding portion 111, and the surfaces 212 press against the guiding portions 111 of the positioners 11. As such, the positioners 11 are pushed and moved toward the second positions. The first end of the positioners 11 is opened, allowing insertion end 21 to move into the main body 1. After the insertion end 21 is inserted in the main body 1, the positioners 11 are returned to the first positions by pressing of the elastic mechanism 12. The hook portions 112 block the insertion end 21. Thus, the main body 1 and the cable head 2 are unable to be separated from each other, as shown in FIG. 4. In other possible embodiments, the main body may have single positioner disposed thereon. Taking two positioners is one of the possible options.

The release mechanism 3 selectively drives the positioners 11 to move to the second positions. In the present embodiment, the release mechanism 3 includes a lock 31, a second pushing portion 32, and a key 33. The second pushing portion 32 is disposed on the lock 31. The second pushing portion 32 can rotate with respect to the lock 31. The key 33 can be inserted in the lock 31, driving the second pushing portion 32 to rotate. As the second pushing portion 32 rotates, the guiding surface 113 of the positioners 11 are pressed by the second pushing portion 32, as shown in FIG. 1 and FIG. 5. The second pushing portion 32 is then located between the positioners 11. The first ends of the positioners 11 are moved away from each other. Thus, blocking of the insertion end 21 achieved by the hook portions 112 is relieved. Therefore, by operating the key 33, the second pushing portion 32 can be controlled to push the positioners 11, moving the positioners 11 to the second positions thereof. Blocking of the insertion end 21 achieved by the hook portions 112 is then relieved, and the cable head 2 can be removed from the main body 1. Beside, the lock of the release mechanism can be replaced by other suitable locks which need no key to be operated, such as combination locks.

Accordingly, in practical using, the main body can be fixed on the structure which users want to protect. For example, the main body can be firmly disposed on the keyboard 4 of a laptop personal computer, such as shown in FIG. 4 and FIG. 5. Accompanied, the release mechanism 3 is disposed near to the main body 1. When user is going to lock the computer, the cable head 2 is inserted in the main body 1. In the insertion, the insertion end 21 of the cable head 2 presses against and separates the positioners 11, allowing the insertion end 21 to move in the main body 1. After the insertion end 21 inserts in the main body 1, the positioners 11 are pressed and returned to the first positions by the elastic mechanism 12. The positioners 11 block the insertion end 21, as shown in FIG. 1 and FIG. 4. The cable head 2 and the main body 1 are unable to be separated from each other. When user is going to release or remove the computer, the key 33 is inserted in the lock 31, driving the second pushing portion 32 to rotate. The second pushing portion 32 presses against the positioners 11 toward the second positions. The hook portions 112 are then separated, as shown in FIG. 1, FIG. 3, and FIG. 5. Blocking of the insertion end 21 caused by the positioners 11 is relieved. User can draw the cable head out of the main body, separating the cable head and the main body.

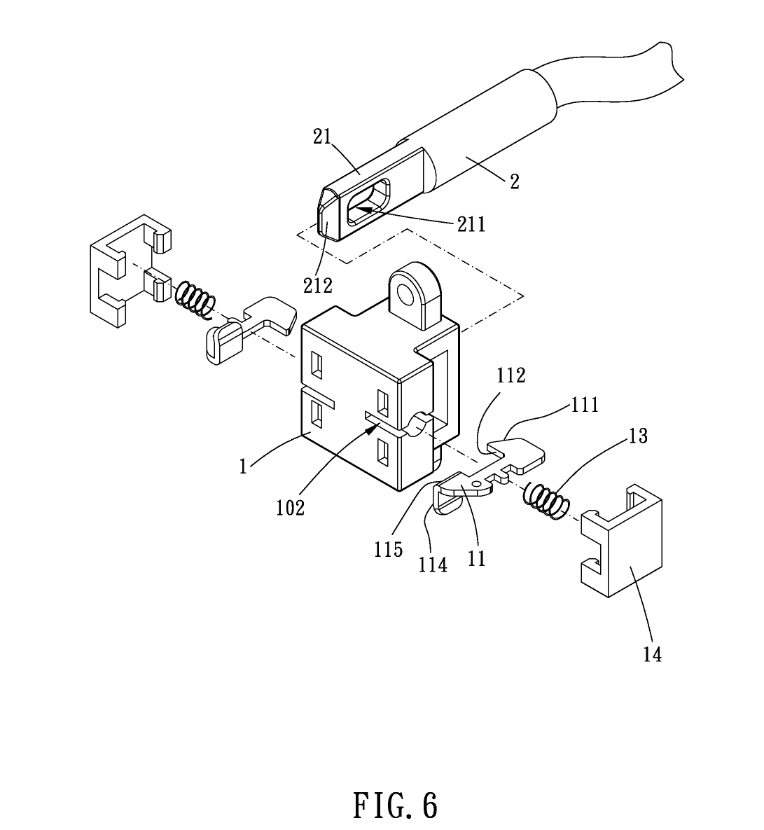

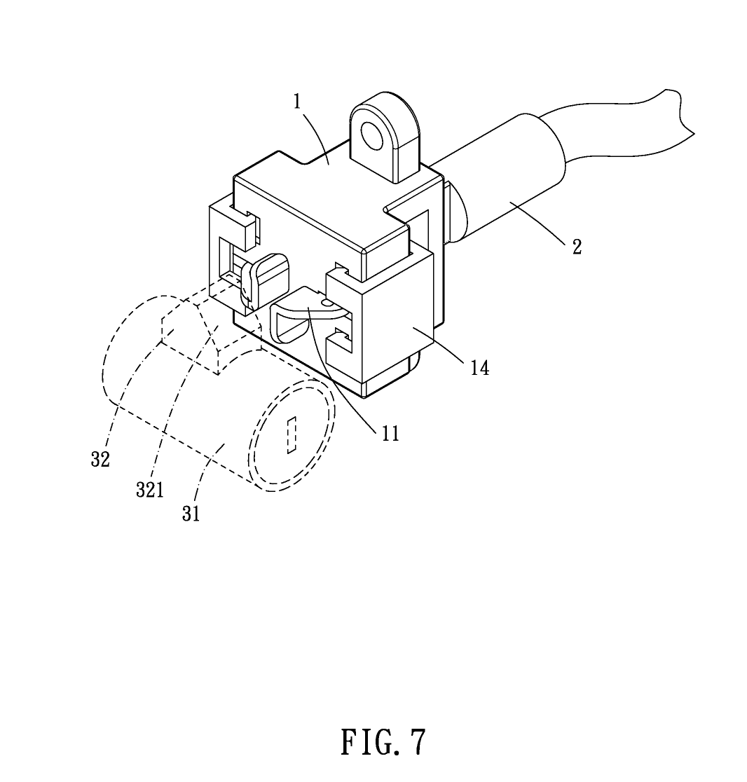

Please refer to FIG. 6 to FIG. 8 for a second embodiment of the present invention. In the second embodiment, the engagement structure is similar to the engagement structure described in the first embodiment except that the main body 1 is formed with two grooves 102 and has two fixation members 14 disposed thereon. The positioners 11 are inserted in the grooves 102, disposed slidably on the main body 1. The fixation members 14 are removably engaged with two corresponding sides of the main body 1. The positioners 11 are restricted by the fixation members 14, so that the positioners 11 are unable to move apart from the main body 1. The positioners 11 has guiding surfaces 114 which is located at one end of the positioners 11 away form the hook portions 112. The guiding surfaces 114 face toward each other. The guiding surfaces 114 are formed with tilted surfaces 115 at the top ends thereof. The elastic mechanism includes two springs 13 each of which is disposed between a positioner 11 and a fixation member 14. The springs 13 press the positioners 11, so that the positioners 11 are moved toward the first positions. In other word, the positioners 11 have tendency to move close to each other. The second pushing portion 32 is formed with two pushing surfaces 321 which slant with respect to each other. Thus, the end portion of the second pushing portion 32 is shrunk as a ridge or a pyramid. The pushing portion 32 presses on the positioners 11 by the pushing surfaces 321.

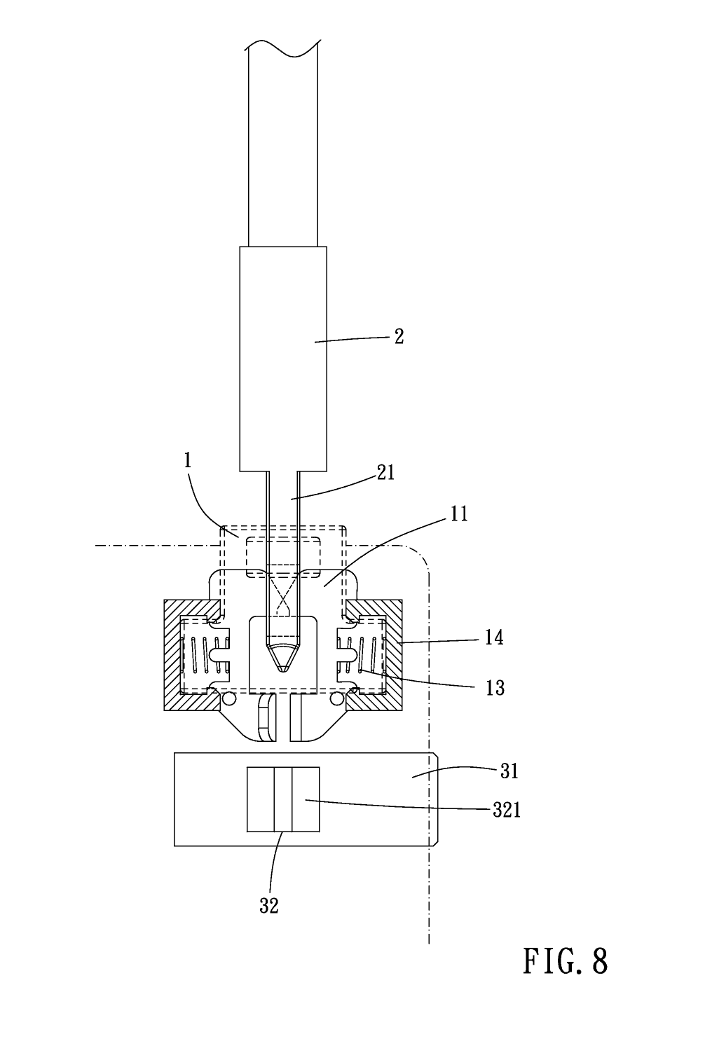

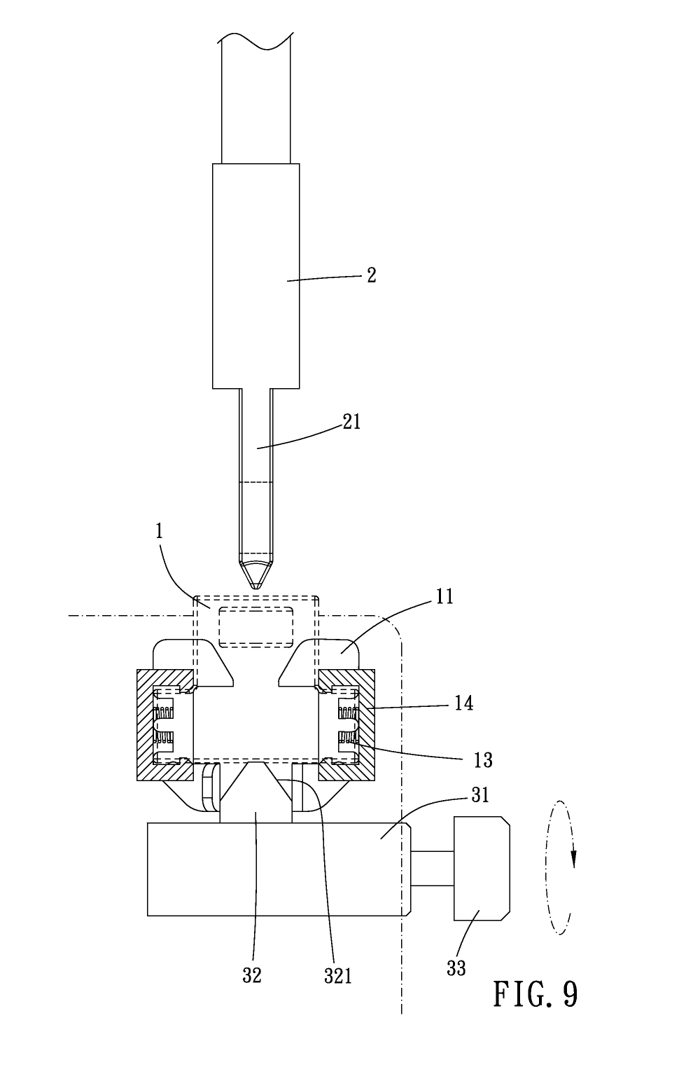

Accordingly, when user is going to lock a computer, only the insertion of the insertion end 21 of the cable head 2 into the main body 1 should be processed. When the insertion end 21 is inserted in the main body 1, the insertion end 21 can press against the positioners 11 to move away form each other. Thus, the insertion end 21 can move in the main body 1. The positioners 11 are then driven to move close to each other by the springs 13, blocking the insertion end 21. Thus, the cable head 2 and main body 1 are unable to be separated from each other. When user is going to release or remove the computer, the key 33 is used for rotating the second pushing portion 32. During the rotation of the second pushing portion 32, the pushing surfaces 321 touch the tilted surfaces 115 of the positioners 11. The positioners 11 are then pressed and moved away form each other, as shown in FIG. 8 and FIG. 9. Blocking of the insertion end 21 achieved by the positioners 11 is relieved, and user can remove the cable head 2 form the main body 1.

Therefore, user can insert the cable head in the main body, locking the cable head and the main body quickly and automatically. The cable head is unable to be removed from the main body directly. For removing the cable head, user should only insert and rotate the key, the engagement of the cable head and the main body is then relieved. The cable head is then removable from the main body. As such, the operation of locking and releasing preformed is quick, easy, and convenient. In addition, the main body and the release mechanism are two individual components (only the contact of the second pushing portion and the positioners are necessary). The main body and the release mechanism can be settled to hide the release mechanism. For example, the release mechanism can be settled away form the user of the computer. The release mechanism can be hidden for burglarproof.

What is claimed is:

1. An engagement structure for cable head, comprising:
a main body, having at least a positioner and an elastic mechanism disposed thereon, the positioner being able to move with respect to the main body between a first position and a second position, the elastic mechanism driving the positioner to move toward the first position;
a cable head, one end thereof being formed with an insertion end, the insertion end inserting removably in the main body, the positioner blocking the insertion end when the positioner is located at the first position, so that the main body and the cable head are unable to be separated from each other, the insertion end being able to move in and out from the main body arbitrarily when the positioner is located at the second position, the insertion end having a first pushing portion, the first pushing portion pressing the positioner toward the second position during motion of the insertion end inserting in the main body, the positioner being moved to the first position by the elastic mechanism and blocking the insertion end after the insertion end is inserted in the main body;
a release mechanism, selectively driving the positioner to move to the second position.

2. The engagement structure for cable head of claim 1, wherein the positioner pivots on the main body.

3. The engagement structure for cable head of claim 1, wherein the positioner has a guiding portion, when the insertion end inserts in the main body, the first pushing portion presses on the guiding portion, driving the positioner to move toward the second position.

4. The engagement structure for cable head of claim 2, wherein the positioner has a guiding portion, when the insertion end inserts in the main body, the first pushing portion presses on the guiding portion, driving the positioner to move toward the second position.

5. The engagement structure for cable head of claim 1, wherein one end of the positioner has a hook portion, the insertion end of the cable head has a limiting portion, the hook portion blocks the limiting portion when the positioner is located at the first position.

6. The engagement structure for cable head of claim 2, wherein one end of the positioner has a hook portion, the insertion end of the cable head has a limiting portion, the hook portion blocks the limiting portion when the positioner is located at the first position.

7. The engagement structure for cable head of claim 1, wherein the main body has two positioners disposed thereon.

8. The engagement structure for cable head of claim 2, wherein the main body has two positioners disposed thereon.

9. The engagement structure for cable head of claim 7, wherein the elastic mechanism is disposed on the main body, pressing the positioners to move toward the first positions of the positioners.

10. The engagement structure for cable head of claim 8, wherein the elastic mechanism is disposed on the main body, pressing the positioners to move toward the first positions of the positioners.

11. The engagement structure for cable head of claim 7, wherein the positioners are located at two corresponding sides of the insertion end when the insertion end is inserted in the main body.

12. The engagement structure for cable head of claim 8, wherein the positioners are located at two corresponding sides of the insertion end when the insertion end is inserted in the main body.

13. The engagement structure for cable head of claim 1, wherein the main body has two positioners disposed thereon, the release mechanism has a second pushing portion, the second pushing portion selectively presses the positioners to move to the second positions of the positioners.

14. The engagement structure for cable head of claim 1, wherein the positioner is slidably disposed on the main body.

15. The engagement structure for cable head of claim 14, wherein the main body has two positioners disposed thereon, the release mechanism has a second pushing portion, the second pushing portion selectively presses the positioners to move to the second positions of the positioners, the second pushing portion presses on the positioners by two pushing surfaces of the second pushing portion.
